(19) United States
(12) Patent Application Publication
(10) Pub. No.: US 2017/0071199 A1
(43) Pub. Date: Mar. 16, 2017

(54) Low-Foam Agrochemical Compositions

(71) Applicant: Clariant International Ltd., Muttenz (CH)

(72) Inventors: Peter BAUR, Schondorf (DE); Peter KLUG, Grossostheim (DE); Stefanie WOLF, Frankfurt am Main (DE)

(73) Assignee: Clariant International Ltd., Muttenz (CH)

(21) Appl. No.: 15/120,097

(22) PCT Filed: Feb. 19, 2015
(86) PCT No.: PCT/EP2015/000371

§ 371 Date: Aug. 18, 2016

(30) Foreign Application Priority Data
Feb. 19, 2014 (DE) 102014203032.3
Apr. 30, 2014 (DE) 102014208244.7

(51) Int. Cl. A01N 25/30; A01N 41/10; A01N 37/40; A01N 57/20; A01N 39/04

(52) U.S. Cl. CPC A01N 25/30; A01N 57/20; A01N 39/04; A01N 37/40; A01N 41/10

(57) ABSTRACT

An aqueous agrochemical active-ingredient composition, comprising (a) one or more water-soluble agrochemical active ingredients, (b) one or more alkyl glucamides of formula (I), wherein R1 represents a linear or branched alkyl group comprising 5 to 9 carbon atoms, R2 represents an alkyl group comprising 1 to 3 carbon atoms, (c) represents one or more silicone-based defoamers selected from the group of linear polydimethylsiloxanes and (d) water. For the defoamer, the ratio of dynamic surface tension at a concentration of 2.0 g/l and a surface age of 20 ms in 20 wt % aqueous propylene glycol to the dynamic surface tension under identical conditions in 20 wt % aqueous dipropylene glycol is greater than 1:10 and the ratio of the dynamic surface tension at a concentration of 2.0 g/l and a surface age of 20 ms in 20 wt % propylene glycol to the dynamic surface tension at a concentration of 10.0 g/l and a surface age of 20 ms in tap water is greater than 1:10. Said aqueous agrochemical active-ingredient composition is suitable for manufacturing low-foam application forms of agrochemical active ingredients.

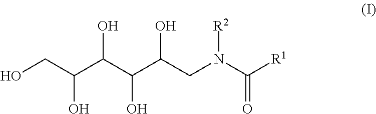

The invention relates to aqueous agrochemical compositions which comprise one or more N-alkylglucamides and defoamers, to the use of the defoamers in compositions comprising N-alkylglucamides, and to methods for controlling pest organisms by applying said composition.

Pesticides (especially herbicides, fungicides, and insecticides) as active agrochemical ingredients are chemical substances, manufactured synthetically or of natural origin, which penetrate plant cells, plant tissues, or parasitic organisms in or on the plant, subjecting them to damage and/or destruction. The largest cohort of these substances is represented by herbicides. Pesticide compositions are used customarily in the form of liquid or solid concentrated preparations (formulations) in agriculture. These preparations make handling easier for the user or ensure greater activity on the part of the active ingredient. The formulations are customarily diluted with water before use and then delivered by spray application.

Water-soluble concentrates (soluble liquids, abbreviated to SL) are a particularly important form of the preparations of pesticide compositions. They play a major role particularly for herbicides, with the active ingredients often being used in the form of water-soluble salts which are converted into their alkali metal salts or ammonium salts by neutralization of the acid form of the herbicides with suitable bases.

A particularly important part is played by the water-soluble salts of herbicides, such as, for example, of glyphosate, of gluphosinate, or of the auxin herbicides such as 2,4-D or dicamba. They are used preferably as the alkali metal salt or in the form of various ammonium salts, or as a mixture of these salts, usually as aqueous formulations.

Other known forms of active agrochemical ingredients are plant nutrients, plant strengtheners, and plant growth regulators.

A general problem affecting the application of active agrochemical ingredients is that only a fraction of the active ingredient develops the desired activity. The greater part is often lost without being utilized, with the active ingredient failing to reach the leaves or roots of the plant when the spray mixture is delivered, and instead seeping unutilized into the soil, being washed off by rain, or failing to be taken up by the plant.

This environmental and economic disadvantage can be reduced by addition of auxiliaries, identified in the context of the present application as “adjuvants”, to agrochemical active ingredient compositions. These adjuvants are able, for example, to reduce spray drift, to improve wetting of the plant, or to ensure that the active ingredient adheres longer to the plant surface and/or is taken up more effectively. Particularly in the case of water-soluble pesticides, such as for glyphosate, for example, the nature and also the amount of the adjuvants used have a decisive influence on the activity of the formulation.

By far the most commonly used adjuvants in aqueous herbicide formulations are fatty amine ethoxylates, primarily tallow fatty amine ethoxylates. On account of their toxic and ecotoxicological properties, however, such as the severe eye irritation or the toxicity toward aquatic organisms, these products are classed as objectionable and are increasingly being replaced by adjuvants having a better toxicological and ecotoxicological profile.

The use of sugar-based surfactants, such as alkyl-N-methylglucosamides, in cleaning products and cosmetic products, for example, is described in the literature (F. W. Lichtenthaler, “Carbohydrates as Organic Raw Materials”, in Ullmann's Ullmann's Encyclopedia of Industrial Chemistry, Wiley-VCH Verlag, 2010).

WO 96/16540 describes pesticide compositions which long-chain alkylamides which carry a polyhydroxycarbonyl substituent having at least three hydroxyl groups on the amide nitrogen. The examples describe emulsifiable concentrates, water-dispersible powders and granules of dodecyl-N methylglucamide, dodecyltetradecyl-N-methylglucamide, and cetylstearyl-N methylglucamide. In examples 6 and 7, the composition further comprises a defoamer.

Silicone-based defoamers are known. However, in some cases they have performance disadvantages, which render them of little apparent suitability for use in formulations of aqueous solutions of polar active plant protection ingredients, especially of saltlike active ingredients such as glufosinate-ammonium. For instance, certain defoamers are of poor solubility in the aqueous formulations, and they separate out in the form of haze, flocs, or phase separations. Other defoamers of this kind no longer exhibit a sufficient defoamer action after the formulation has been stored at room temperature or at an elevated temperature of up to 50 C, for example.

WO 2005/117580 describes silicone-based crop protection product defoamers. EP-A-0407874, on the other hand, mentioned numerous examples of known silicone-based defoamers, which exhibit no properties, or only very unusable properties, as defoamers for aqueous crop protection products with saltlike active ingredients.

The problem which arose was therefore that of providing further adjuvants and adjuvant combinations for use in aqueous agrochemical compositions, which are highly active, which are distinguished by an advantageous toxicological and environmental profile, which exhibit properties advantageous from a performance standpoint, and in particular which exhibit low foaming.

The problem is solved by a combination of relatively short-chain N-alkylglucamides and certain silicone-containing defoamers.

The invention accordingly provides aqueous agrochemical compositions comprising
(a) one or more water-soluble active agrochemical ingredients,
(b) one or more alkylglucamides of the formula (I),

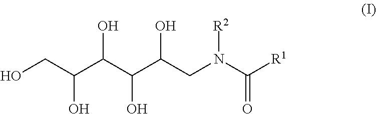

where
R1 is a linear or branched alkyl group having 5 to 9 carbon atoms,
R2 is an alkyl group having 1 to 3 carbon atoms
(c) one or more silicone-based defoamers from the group of the linear polydimethylsiloxanes, and
(d) water,
   where for the defoamer c) the ratio of dynamic surface tension (DYOS in [mN/m]) at a concentration of 2.0 g/l and a surface age of 20 milliseconds (ms) in 20 wt % strength aqueous propylene glycol to the dynamic surface tension under the same conditions in 20 wt % strength aqueous dipropylene glycol is greater than 1.10 and the ratio of the dynamic surface tension at a concentration of 2.0 g/l and a surface age of 20 ms in 20 wt % strength aqueous propylene glycol to the dynamic surface tension at a concentration of 10.0 g/l and a surface age of 20 ms in water is greater than 1.10.

Further provided by the invention is an adjuvant composition which is free from active agrochemical ingredients, comprising

A) one or more glucamides of the invention, of the formula (I), and
B) one or more silicone-based defoamers of the invention.

Likewise provided by the invention is a method for protecting plants from pest organisms, which comprises contacting the plants for protection, the pest organisms and/or the habitat thereof with an agrochemical active ingredient composition of the invention.

Likewise provided by the invention is a method for controlling unwanted plant growth, which comprises applying an effective amount for an agrochemical active ingredient composition of the invention to the plants, parts of plants, or the area under cultivation.

Further provided by the invention is the use of a silicone-based defoamer of the invention from the group of the linear polydimethylsiloxanes as defoamer for aqueous formulations of water-soluble active agrochemical ingredients, comprising alkylglucamides of the invention, of the formula (I).

The compositions of the invention exhibit not only high biological activity but also outstanding performance properties and, in particular, a low tendency toward foaming.

The term “aqueous agrochemical composition” (composition of the invention) embraces “aqueous agrochemical active ingredient compositions” (active ingredient compositions of the invention) and active ingredient-free, aqueous agrochemical adjuvant-compositions (adjuvant compositions of the invention).

The term “active agrochemical ingredient” embraces pesticides, plant nutrients (fertilizers), plant strengtheners, and plant growth regulators, also in the corresponding compositions.

Preferred active agrochemical ingredients are pesticides and plant nutrients, especially pesticides.

The term “composition” here embraces both the concentrated form (formulation) and the diluted form (spray mixture).

Water-soluble active agrochemical ingredients, especially pesticides, for the purposes of the invention are those active agrochemical ingredients, especially pesticides, which at room temperature (25° C.) have a solubility of more 50 g/l and preferably more than 100 g/l in water. Particularly preferred are active agrochemical ingredients, especially pesticides, which at the deployment concentration at 25° C. have a solubility of at least 90 wt %.

Examples of plant nutrients as active agrochemical ingredients include customary organic or inorganic fertilizers for supplying plants with macro and/or micronutrients.

Examples of plant growth regulators as active agrochemical ingredients further include natural plant hormones such as abscissic acid, jasmonic acid, salicylic acid and the esters thereof, kinetin and brassinosteroids.

Mention may further be made of active agrochemical ingredients which can act as plant growth regulators and/or plant strengtheners, in order to lessen the influence of stress factors such as heat, cold, drought, salt, oxygen deficiency or oxygen flooding on plant growth. Here, mention may be made, by way of example, of glycine betaine (betaine), choline, potassium phosphate, or other phosphate salts, and also silicates.

Preferred pesticides include fungicides, bactericides, insecticides, acaricides, nematicides, herbicides, and repellents.

Preferred water-soluble pesticides (component a) are acifluorfen, aminopyralid, amitrole, asulam, benazolin, bentazone, bialaphos, bicyclopyrone, bispyribac, bromacil, bromoxynil, chloramben, clopyralid, 2,4-D, 2,4-DB, dicamba, dichlorprop, dichlorprop-P, difenzoquat, diquat, endothal, fenoxaprop, fenoxaprop-P, flamprop, florasulam, flumiclorac, fluoroglycofen, fluroxypyr, fomesafen, fosamine, glufosinate, glufosinate-P, glyphosate, imazameth, imazamethabenz, imazamox, imazapic, imazapyr, imazaquin, imazethapyr, MCPA, MCPB, mecoprop, mesotrione, nicosulfuron, octanoic acid, pelargonic acid, picloram, quizalofop, quizalofop-P, 2,3,6-TBA, sulcotrione, tembotrione, and triclopyr, preferably in each case in the form of their water-soluble salts.

Preferred salts here are exemplified by acifluorfen-sodium, bialafos-sodium, bispyridac-sodium, glufosinate-ammonium, glufosinate-P-ammonium, glufosinate-P-sodium, glyphosate-isopropylammonium, glyphosate-trimesium, imazamox-ammonium, imazapyr-isopropylammonium, imazaquin-ammonium, imazethapyr-ammonium, MCPB-sodium, mecocrop-sodium, mecocrop-P-dimethylammonium, and mecocrop-P-potassium.

Particularly preferred are the water-soluble salts of 2,4-D, bentazone, dicamba, fomesafen, glyphosate, glufosinate, MCPA, and paraquat. Especially preferred are the water-soluble salts of glyphosate.

Among the water-soluble salts, particular preference is given in each case to the alkali metal salts and ammonium salts, and of these in turn to the potassium, ammonium, dimethylammonium, isopropylammonium, and the (2 hydroxyethyl)trimethylammonium salts.

The water-soluble pesticides of component a) may also comprise a combination of two pesticides or of a plurality of pesticides, more particularly of the preferred pesticides identified above. Such combinations are especially important when, for example, the task at hand is to broaden the activity spectrum of the pesticide composition or to suppress more effectively resistances toward particular pesticides.

In a further embodiment of the invention, therefore, the active ingredient compositions of the invention comprise at least two water-soluble active ingredients of component a).

The at least two water-soluble active ingredients are preferably selected from glyphosate, glufosinate, 2,4-D, dicamba, and fomesafen.

Particularly preferred compositions are those where the water-soluble active ingredients of component a) comprise the combinations of the two herbicides glyphosate and 2,4-D, glyphosate and dicamba, glyphosate and fomesafen, glyfosate and glufosinate, 2,4-D and dicamba, glufosinate and 2,4-D, and glufosinate and dicamba.

The compositions of the invention may additionally comprise, in the formulation or else in the spray mixture, further pesticides, which may be present in solution or else in dispersed form.

Identified hereinafter are, further, examples of pesticides which may be present in solution as component a) or which may form combination partners to pesticides of component a).

Examples of herbicides include:

Active ingredients based on inhibition of, for example, acetolactate synthase, acetyl-CoA carboxylase, cellulose synthase, enolpyruvylshikimate-3-phosphate synthase, glutamine synthetase, p-hydroxyphenylpyruvate dioxygenase, phytoendesaturase, photosystem I, photosystem II, protoporphyrinogen oxidase, can be used, as described, for example, in Weed Research 26 (1986) 441-445 or “The Pesticide Manual”, 16th edition, The British Crop Protection Council and the Royal Soc. of Chemistry, 2012 and literature cited therein. Examples of known herbicides or plant growth regulators which can be combined with the inventive compounds include the active ingredients which follow (the compounds are designated by the “common name” according to the International Organization for Standardization (ISO) or by the chemical name or by the code number) and always encompass all use forms, such as acids, salts, esters and isomers, such as stereoisomers and optical isomers. One administration form or else, in some cases, more than one administration form is mentioned by way of example:

acetochlor, acibenzolar, acibenzolar-S-methyl, aclonifen, alachlor, allidochlor, alloxydim, alloxydim-sodium, ametryn, amicarbazone, amidochlor, amidosulfuron, aminocyclopyrachlor, aminocyclopyrachlor-potassium, aminocyclopyrachlor-methyl, amitrole, ammonium sulfamate, ancymidol, anilofos, atrazine, aviglycine, azafenidin, azimsulfuron, aziprotryne, beflubutamid, benazolin-ethyl, bencarbazone, benfluralin, benfuresate, bensulide, bensulfuron, bensulfuron-methyl, benzfendizone, benzobicyclon, benzofenap, benzofluor, benzoylprop, benzyladenine, bifenox, bromobutide, bromofenoxim, bromuron, buminafos, busoxinone, butachlor, butafenacil, butamifos, butenachlor, butralin, butroxydim, butylate, cafenstrole, carbaryl, carbetamide, carfentrazone, carfentrazone-ethyl, carvone, chlorocholine chloride, chlomethoxyfen, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, 4-chlorophenoxyacetic acid, chlorophthalim, chlorpropham, chlorthal-dimethyl, chlortoluron, chlorsulfuron, cinidon, cinidon-ethyl, cinmethylin, cinosulfuron, clethodim, clodinafop, clodinafop-propargyl, clofencet, clomazone, clomeprop, cloprop, cloransulam, cloransulam-methyl, cloxyfonac, cumyluron, cyanamide, cyanazine, cyclanilide, cycloate, cyclosulfamuron, cycloxydim, cycluron, cyhalofop, cyhalofop-butyl, cyperquat, cyprazine, cyprazole, cytokinine, daimuron/dymron, dalapon, daminozide, dazomet, n-decanol, desmedipham, desmetryn, detosyl-pyrazolate (DTP), diallate, diaminozide, dichlobenil, diclofop, diclofop-methyl, diclofop-P-methyl, diclosulam, diethatyl, diethatyl-ethyl, difenoxuron, diflufenican, diflufenzopyr, diflufenzopyr-sodium, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, diisopropylnaphthalene, dipropetryn, diquat-dibromide, dithiopyr, diuron, DNOC, eglinazine-ethyl, EPTC, esprocarb, ethalfluralin, ethametsulfuron, ethametsulfuron-methyl, ethyl naphthylacetate, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop-ethyl, fenoxaprop-P-ethyl, fenoxasulfone, fentrazamide, fenuron, flamprop-M-isopropyl, flamprop-M-methyl, flazasulfuron, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac-pentyl, flumioxazin, flumipropyn, fluometuron, fluorodifen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr-meptyl, flurprimidol, flurtamone, fluthiacet, fluthiacet-methyl, fluthiamide, foramsulfuron, forchlorfenuron, furyloxyfen, gibberellic acid, H-9201, i.e. O-(2,4-dimethyl-6-nitrophenyl) O-ethyl isopropylphosphoramidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, imazamethabenz-methyl, imazosulfuron, inabenfide, indanofan, indaziflam, indoleacetic acid (IAA), 4-indol-3-ylbutyric acid (IBA), iodosulfuron, iodosulfuron-methyl-sodium, iofensulfuron, iofensulfuron-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, karbutilate, ketospiradox, lactofen, lenacil, linuron, maleic hydrazide, MCPB-methyl, -ethyl mecoprop-butotyl, mecoprop-P-butotyl, mecoprop-P-ethylhexyl, mefenacet, mefluidide, mepiquat-chloride, mesosulfuron, mesosulfuron-methyl, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazin-3-amine, MT-5950, i.e. N-[3-chloro-4-(1-methylethyl)phenyl]-2-methylpentanamide, NGGC-011, 1-naphthylacetic acid (NAA), naphthylacetamide (NAAm), 2-naphthoxyacetic acid, naproanilide, napropamide, naptalam, NC-310, i.e. 4-(2,4-dichlorobenzoyl)-1-methyl-5-benzyloxypyrazole, neburon, nipyraclofen, nitralin, nitrofen, nitroguaiacolate, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pendimethalin, pendralin, penoxsulam, pentanochlor, pentoxazone, perfluidone, pethoxamid, phenisopham, phenmedipham, phenmedipham-ethyl, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-naphthyl}oxy)propanoate, sulfallate (CDEC), sulfentrazone, sulfometuron, sulfometuron-methyl, sulfosulfuron, SW-065, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tepraloxydim, terbacil, terbucarb, terbuchlor, terbumeton, terbuthylazine, terbutryne, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triafamone, triallate, triasulfuron, triaziflam, triazofenamide, tribenuron, tribenuron-methyl, tribufos, trichloroacetic acid (TCA), tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0862, i.e. 3,4-dichloro-N-{2-[(4,6-dimethoxypyrimidin-2-yl)oxy]benzyl}aniline, and the following compounds:

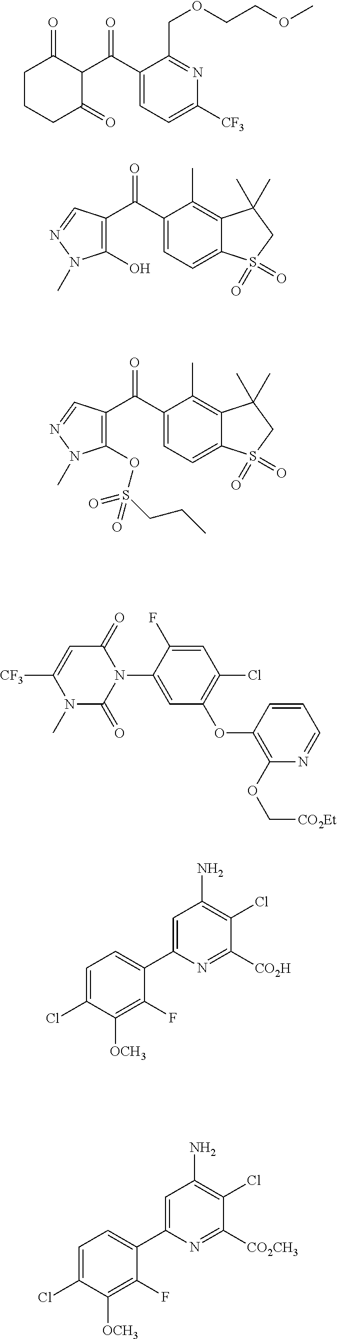 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(-n2c(=O)cc(C(F)(F)F)n(C)c2=O)c(F)cc1Cl ; COc1c(Cl)ccc(-c2cc(N)c(Cl)c(C(=O)O)n2)c1F ; COC(=O)c1nc(-c2ccc(Cl)c(OC)c2F)cc(N)c1Cl]

Examples of fungicides include:

(1) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-[1-(4-methoxyphenoxy)-3,3-dimethylbutan-2-yl] 1H-imidazole-1-carbothioate.
(2) Respiration inhibitors (respiratory chain inhibitors), for example bixafen, boscalid, carboxin, diflumetorim, fenfuram, fluopyram, flutolanil, fluxapyroxad, furametpyr, furmecyclox, isopyrazam mixture of the syn-epimeric racemate 1RS,4SR,9RS and of the anti-epimeric racemate 1RS,4SR,9SR, isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.
(3) Respiration inhibitors (respiratory chain inhibitors) acting on complex III of the respiratory chain, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide and (2R)-2-{2-[(2,5-dimethylphenoxy)methyl]phenyl}-2-methoxy-N-methylacetamide.
(4) Mitosis and cell division inhibitors, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.
(5) Compounds with multisite activity, for example Bordeaux mixture, captafol, captan, chlorothalonil, copper preparations such as copper hydroxide, copper naphthenate, copper oxide, copper oxychloride, copper sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulfur and sulfur preparations, for example calcium polysulfide, thiram, tolylfluanid, zineb and ziram.
(6) Resistance inductors, for example acibenzolar-S-methyl, isotianil, probenazole and tiadinil.
(7) Amino acid and protein biosynthesis inhibitors, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.
(8) ATP production inhibitors, for example fentin acetate, fentin chloride, fentin hydroxide and silthiofam.
(9) Cell wall synthesis inhibitors, for example benthiavalicarb, dimethomorph, flumorph, iprovalicarb, mandipropamid, polyoxins, polyoxorim, validamycin A and valifenalate.
(10) Lipid and membrane synthesis inhibitors, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.
(11) Melanin biosynthesis inhibitors, for example carpropamid, diclocymet, fenoxanil, fthalide, pyroquilon, tricyclazole and 2,2,2-trifluoroethyl {3-methyl-1-[(4-methylbenzoy)amino]butan-2-yl}carbamate.
(12) Nucleic acid synthesis inhibitors, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.
(13) Signal transduction inhibitors, for example chlozolinate, fenpiclonil, fludioxonil, iprodione, procymidone, quinoxyfen and vinclozolin.
(14) Decouplers, for example binapacryl, dinocap, ferimzone, fluazinam and meptyldinocap.
(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulfate, diphenylamine, ecomat, fenpyrazamine, flumetover, fluoromide, flusulfamide, flutianil, fosetyl-aluminum, fosetyl-calcium, fosetyl-sodium, hexachlorobenzene, irumamycin, methasulfocarb, methyl isothiocyanate, metrafenon, mildiomycin, natamycin, nickel dimethyldithiocarbamate, nitrothal-isopropyl, octhilinone, oxamocarb, oxyfenthiin, pentachlorophenol and salts thereof, phenothrin, phosphoric acid and salts thereof, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrrolnitrin, tebufloquin, tecloftalam, tolnifanid, triazoxide, trichlamide, zarilamide, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2,6-dimethyl-1H,5H-[1,4]dithiino[2,3-c:5,6-c′]dipyrrole-1,3,5,7(2H,6H)-tetrone, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts thereof, 3-(4,4,5-trifluoro-3,3-dimethyl-3,4-dihydroisoquinolin-1-yl)quinoline, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-fluoro-2-[(4-fluorobenzyl)oxy]pyrimidin-4-amine, 5-fluoro-2-[(4-methylbenzyl)oxy]pyrimidin-4-amine, 5-methyl-6-octyl[1,2,4]triazolo[1,5-a]pyrimidin-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethylphenyl)-N-ethyl-N-methylimidoformamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N—{(Z)-[(cyclopropylmethoxy)imino][6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylimidoformamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperid-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]amino}oxy)methyl]pyridin-2-yl}carbamate.
(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone, N-[2-(4-{[3-(4-chlorophenyl)prop-2-yn-1-yl]oxy}-3-methoxyphenyl)ethyl]-N2-(methylsulfonyl)valinamide, 4-oxo-4-[(2-phenylethy)amino]butanoic acid and but-3-yn-1-yl {6-[({[(Z)-(1-methyl-1H-tetrazol-5-yl)(phenyl)methylene]amino}oxy)methyl]pyridin-2-yl}carbamate.

All stated fungicides (1) to (16) can, if they are capable on the basis of their functional groups, optionally form salts with suitable bases or acids.

Examples of bactericides include the following:

bronopol, dichlorophen, nitrapyrin, nickel dimethyldithiocarbamate, kasugamycin, octhilinon, furancarboxylic acid, oxytetracycline, probenazole, streptomycin, tecloftalam, copper sulfate and other copper preparations.

Examples of insecticides, acaricides and nematicides include the following:

(1) Acetylcholinesterase (AChE) inhibitors, such as, for example, carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or
organophosphates, for example acephate, azamethiphos, azinphos (-methyl, -ethyl), cadusafos, chlorethoxyfos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.
(2) GABA-gated chloride channel antagonists, such as, for example, cyclodiene organochlorines, for example chlordane and endosulfan; or phenylpyrazoles (fiproles), for example ethiprole and fipronil.
(3) Sodium channel modulators/voltage-dependent sodium channel blockers, such as, for example,
pyrethroids, for example acrinathrin, allethrin (d-cis-trans, d-trans), bifenthrin, bioallethrin, bioallethrin-S-cyclopentenyl isomer, bioresmethrin, cycloprothrin, cyfluthrin (beta-), cyhalothrin (gamma-, lambda-), cypermethrin (alpha-, beta-, theta-, zeta-), cyphenothrin [(IR)-trans-isomers], deltamethrin, empenthrin [(EZ)-(IR)-isomers], esfenvalerate, etofenprox, fenpropathrin, fenvalerate, flucythrinate, flumethrin, fluvalinate (tau-), halfenprox, imiprothrin, kadethrin, permethrin, phenothrin [(IR)-trans-isomer], prallethrin, pyrethrins (pyrethrum), resmethrin, silafluofen, tefluthrin, tetramethrin, tetramethrin [(IR)-isomers], tralomethrin, and transfluthrin; or
DDT; or methoxychlor.
(4) Nicotinergic acetylcholine receptor (nAChR) agonists, such as, for example, neonicotinoids, for example acetamiprid, clothianidin, dinotefuran, imidacloprid, nitenpyram, thiacloprid, and thiamethoxam; or nicotine.
(5) Nicotinergic acetylcholine receptor (nAChR) allosteric activators, such as, for example,
spinosyns, for example spinetoram and spinosad.
(6) Chloride channel activators, such as, for example,
avermectins/milbemycins, for example abamectin, emamectin benzoate, lepimectin and milbemectin.
(7) Juvenile hormone imitators, such as, for example
juvenile hormone analogues, for example hydroprene, kinoprene, and methoprene; or fenoxycarb; or pyriproxyfen.
(8) Active ingredients with unknown or non-specific mechanisms of action, such as, for example,
alkyl halides, for example methyl bromide and other alkyl halides; or chloropicrin; or sulfuryl fluoride; or borax; or tartar emetic.
(9) Selective antifeedants, for example pymetrozine; or flonicamid.
(10) Mite growth inhibitors, for example clofentezine, hexythiazox and diflovidazin; or etoxazole.
(11) Microbial disruptors of the insect gut membrane, such as, for example, Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.
(12) Oxidative phosphorylation inhibitors, ATP disruptors, such as, for example, diafenthiuron; or organotin compounds, for example azocyclotin, cyhexatin and fenbutatin oxide; or propargite; or tetradifon.
(13) Oxidative phosphorylation decouplers acting by interrupting the H proton gradient, such as, for example,
chlorfenapyr, DNOC and sulfluramid.
(14) Nicotinergic acetylcholine receptor antagonists, such as, for example, bensultap, cartap hydrochloride, thiocyclam, and thiosultap sodium.
(15) Chitin biosynthesis inhibitors, type 0, such as, for example,
bistrifluron, chlorfluazuron, diflubenzuron, flucycloxuron, flufenoxuron, hexaflumuron, lufenuron, novaluron, noviflumuron, teflubenzuron and triflumuron.
(16) Chitin biosynthesis inhibitors, type 1, such as, for example, buprofezin.
(17) Molting disruptors, dipteran, such as, for example, cyromazine.
(18) Ecdysone receptor agonists, such as, for example, chromafenozide, halofenozide, methoxyfenozide and tebufenozide.
(19) Octopaminergic agonists, such as, for example, amitraz.
(20) Complex-III electron transport inhibitors, such as, for example, hydramethylnon; or acequinocyl; or fluacrypyrim.
(21) Complex-I electron transport inhibitors, for example
METI acaricides, for example fenazaquin, fenpyroximate, pyrimidifen, pyridaben, tebufenpyrad and tolfenpyrad; or rotenone (Derris).
(22) Voltage-dependent sodium channel blockers, for example indoxacarb; or metaflumizone.
(23) Inhibitors of acetyl-CoA carboxylase, such as
tetronic and tetramic acid derivatives, for example spirodiclofen, spiromesifen and spirotetramat.
(24) Complex-IV electron transport inhibitors, such as, for example,
phosphines, for example aluminum phosphide, calcium phosphide, phosphine and zinc phosphide; or cyanide.
(25) Complex-II electron transport inhibitors, such as cyenopyrafen.
(26) Ryanodine receptor effectors, such as
diamides, for example chlorantraniliprole and flubendiamide.

Further active ingredients with unknown mechanism of action, such as amidoflumet, azadirachtin, benclothiaz, benzoximate, bifenazate, bromopropylate, chinomethionat, cryolite, cyantraniliprole (cyazypyr), cyflumetofen, dicofol, diflovidazin, fluensulfone, flufenerim, flufiprole, fluopyram, fufenozide, imidaclothiz, iprodione, pyridalyl, pyrifluquinazon and iodomethane; and also products based on Bacillus firmus (I-1582, BioNeem, Votivo) and also the known active compounds below:

3-bromo-N-{2-bromo-4-chloro-6-[(1-cyclopropylethyl)carbamoyl]phenyl}-1-(3-chloropyridin-2-yl)-1H-pyrazole-5-carboxamide (known from WO 2005/077934), 4-{[(6-bromopyrid-3-yl)methyl](2-fluoroethyl)amino}furan-2(5H)-one (known from WO 2007/115644), 4-{[(6-fluoropyrid-3-yl)methyl](2,2-difluoroethy)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethy)amino}furan-2(5H)-one (known from WO 2007/115644), 4-{[(6-chloropyrid-3-yl)methyl](2,2-difluoroethy)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl](cyclopropyl)amino}furan-2(5H)-one (known from EP-A 0 539 588), 4-{[(6-chloropyrid-3-yl)methyl](methyl)amino}furan-2(5H)-one (known from EP-A 0 539 588), {[1-(6-chloropyridin-3-yl)ethyl](methyl)oxido-λ4-sulfanylidene}cyanamide (known from WO 2007/149134) and its diastereomers {[(1R)-1-(6-chloropyridin-3-yl)ethyl](methyl)oxido-λ4-sulfanylidene}cyanamide (A) and {[(1S)-1-(6-chloropyridin-3-yl)ethyl](methyl)oxido-λ4-sulfanylidene}cyanamide (B) (likewise known from WO 2007/149134) and also sulfoxaflor (likewise known from WO 2007/149134) and its diastereomers [(R)-methyl(oxido){(1R)-1-[6-(trifluoromethyl)pyridin-3-yl]ethyl}-λ4-sulfanylidene]cyanamide (A1) and [(S)-methyl(oxido){(1S)-1-[6-(trifluoromethyl)pyridin-3-yl]ethyl}-λ4-sulfanylidene]cyanamide (A2), identified as diastereomer group A (known from WO 2010/074747, WO 2010/074751), [(R)-methyl(oxido){(1S)-1-[6-(trifluoromethyl)pyridin-3-yl]ethyl}-λ4-sulfanylidene]cyanamide (B1) and [(S)-methyl(oxido){(1R)-1-[6-(trifluoromethyl)pyridin-3-yl]ethyl}-λ4-sulfanylidene]cyanamide (B2), identified as diastereomer group B (likewise known from WO 2010/074747, WO 2010/074751) and 11-(4-chloro-2,6-dimethylphenyl)-12-hydroxy-1,4-dioxa-9-azadispiro[4.2.4.2]tetradec-11-en-10-one (known from WO 2006/089633), 3-(4′-fluoro-2,4-dimethylbiphenyl-3-yl)-4-hydroxy-8-oxa-1-azaspiro[4.5]dec-3-en-2-one (known from WO 2008/067911), 1-{2-fluoro-4-methyl-5-[(2,2,2-trifluoroethyl)sulfinyl]phenyl}-3-(trifluoromethyl)-1H-1,2,4-triazol-5-amine (known from WO 2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO 2008/066153), 2-cyano-3-(difluoromethoxy)-N,N-dimethylbenzenesulfonamide (known from WO 2006/056433), 2-cyano-3-(difluoromethoxy)-N-methylbenzenesulfonamide (known from WO 2006/100288), 2-cyano-3-(difluoromethoxy)-N-ethylbenzenesulfonamide (known from WO 2005/035486), 4-(difluoromethoxy)-N-ethyl-N-methyl-1,2-benzothiazol-3-amine 1,1-dioxide (known from WO 2007/057407), N-[1-(2,3-dimethylphenyl)-2-(3,5-dimethylphenyl)ethyl]-4,5-dihydro-1,3-thiazol-2-amine (known from WO 2008/104503), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO 2003/106457), 3-(2,5-dimethylphenyl)-4-hydroxy-8-methoxy-1,8-diazaspiro[4.5]dec-3-en-2-one (known from WO 2009/049851), 3-(2,5-dimethylphenyl)-8-methoxy-2-oxo-1,8-diazaspiro[4.5]dec-3-en-4-ylethyl carbonate (known from WO 2009/049851), 4-(but-2-yn-1-yloxy)-6-(3,5-dimethylpiperidin-1-yl)-5-fluoropyrimidine (known from WO 2004/099160), (2,2,3,3,4,4,5,5-octafluoropentyl)(3,3,3-trifluoropropyl)malononitrile (known from WO 2005/063094), (2,2,3,3,4,4,5,5-octafluoropentyl)(3,3,4,4,4-pentafluorobutyl)malononitrile (known from WO 2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (known from WO 2007/040280), 2-ethyl-7-methoxy-3-methyl-6-[(2,2,3,3-tetrafluoro-2,3-dihydro-1,4-benzodioxin-6-yl)oxy]quinolin-4-yl methyl carbonate (known from JP2008/110953), 2-ethyl-7-methoxy-3-methyl-6-[(2,2,3,3-tetrafluoro-2,3-dihydro-1,4-benzodioxin-6-yl)oxy]quinolin-4-ylacetate (known from JP2008/110953), PF1364 (CAS Reg. No. 1204776-60-2) (known from JP 2010/018586), 5-[5-(3,5-dichlorophenyl)-5-(trifluoromethyl)-4,5-dihydro-1,2-oxazol-3-yl]-2-(1H-1,2,4-triazol-1-yl)benzonitrile (known from WO 2007/075459), 5-[5-(2-chloropyridin-4-yl)-5-(trifluoromethyl)-4,5-dihydro-1,2-oxazol-3-yl]-2-(1H-1,2,4-triazol-1-yl)benzonitrile (known from WO 2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide (known from WO 2005/085216), 4-{[(6-chloropyridin-3-yl)methyl](cyclopropyl)amino}-1,3-oxazol-2(5H)-one, 4-{[(6-chloropyridin-3-yl)methyl](2,2-difluoroethyl)amino}-1,3-oxazol-2(5H)-one, 4-{[(6-chloropyridin-3-yl)methyl](ethyl)amino}-1,3-oxazol-2(5H)-one, 4-{[(6-chloropyridin-3-yl)methyl](methyl)amino}-1,3-oxazol-2(5H)-one (all known from WO 2010/005692), NNI-0711 (known from WO2002/096882), 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide (known from WO 2002/096882), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO 2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO 2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO 2005/085216), methyl 2-[3,5-dibromo-2-({[3-bromo-1-(3-chloropyridin-2-yl)-1H-pyrazol-5-yl]carbonyl}amino)benzoyl]-1,2-diethylhydrazinecarboxylate (known from WO 2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO 2005/085216), (5RS,7RS;5RS,7SR)-1-(6-chloro-3-pyridylmethyl)-1,2,3,5,6,7-hexahydro-7-methyl-8-nitro-5-propoxyimidazo[1,2-a]pyridine (known from WO 2007/101369), 2-{6-[2-(5-fluoropyridin-3-yl)-1,3-thiazol-5-yl]pyridin-2-yl}pyrimidine (known from WO 2010/006713), 2-{6-[2-(pyridin-3-yl)-1,3-thiazol-5-yl]pyridin-2-yl}pyrimidine (known from WO 2010/006713), 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide (known from WO 2010/069502), 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide (known from WO 2010/069502), N-[2-(tert-butylcarbamoyl)-4-cyano-6-methylphenyl]-1-(3-chloropyridin-2-yl)-3-{[5-(trifluoromethyl)-1H-tetrazol-1-yl]methyl}-1H-pyrazole-5-carboxamide (known from WO 2010/069502), N-[2-(tert-butylcarbamoyl)-4-cyano-6-methylphenyl]-1-(3-chloropyridin-2-yl)-3-{[5-(trifluoromethyl)-2H-tetrazol-2-yl]methyl}-1H-pyrazole-5-carboxamide (known from WO 2010/069502), and (1E)-N-[(6-chloropyridin-3-yl)methyl]-N′-cyano-N-(2,2-difluoroethyl)ethanimideamide (known from WO 2008/009360).

The active ingredients identified here by their common name are known and are described, for example, in the pesticide handbook (“The Pesticide Manual” 16^{th} Ed., British Crop Protection Council 2012) or can be searched on the Internet (e.g. http://www.alanwood.net/pesticides).

As component b) the compositions of the invention comprise one or more N-alkylglucamides of the formula (I).

The preparation of the alkylglucamides of the formula (I) has already been adequately described and is known to the skilled person (see, for example, EPO-A 0 550 637 and EP-A 0 285 768). It is accomplished for example by condensing carboxylic esters with a secondary N-alkylglucamine, which itself can be prepared by reductive amination from a sugar such as the preferred D-glucose.

In the one or more alkylglucamides of the formula (I), the radical R1 is preferably a linear or branched alkyl group having 7 to 9 carbon atoms. The radical R2 is preferably a methyl group.

More preferably the compositions of the invention comprise a mixture of octyl-N-methylglucamide (R1=C7 alkyl, R2=methyl) and decyl-N-methylglucamide (R1=C9 alkyl, R2=methyl). The fraction of octyl-N-methylglucamide in this mixture is 10 to 90 wt %, preferably 20 to 80 wt %, and more preferably 30 to 70 wt %, based on the total amount of the alkylglucamides present in this mixture. The fraction of decyl-N-methylglucamide in this mixture is 10 to 90 wt %, preferably 20 to 80 wt %, and more preferably 30 to 70 wt %, based on the total amount of the alkylglucamides present in this mixture. Preference is also given to nonyl-N-methylglucamide (R1=C8 alkyl, R2=methyl, based on pelargonic acid).

The pentahydroxyhexyl radical in the alkylglucamides of the formula (I) possesses various chiral centers, and so a plurality of stereoisomers may exist in each case. The alkylglucamides of the formula (I) are customarily prepared from naturally occurring sugars, such as D-glucose, although in principle the use of other natural or synthetic hexoses or other C6 building blocks is also possible, and so various stereoisomers of the formula (I) may result.

The compositions of the invention comprise one or more silicone-based defoamers as component c). Defoamers used in accordance with the invention are selected from the group of linear polydimethylsiloxanes, where the ratio of dynamic surface tension (DYOS in [mN/m]) at a concentration of 2.0 g/l and a surface age of 20 milliseconds (ms) in 20 wt % strength aqueous propylene glycol to the dynamic surface tension under the same conditions in 20 wt % strength aqueous dipropylene glycol is greater than 1.10 and the ratio of the dynamic surface tension at a concentration of 2.0 g/l and a surface age of 20 ms in 20 wt % strength aqueous propylene glycol to the dynamic surface tension at a concentration of 10.0 g/l and a surface age of 20 ms in mains water is greater than 1.10.

Defoamers from the group of the linear polydimethylsiloxanes comprise as their chemical scaffold a compound of the formula HO—[Si(CH3)2-O-]n-H, with the end groups being modified, etherified for example, or, generally, connected to the groups —Si(CH3)3.

Defoamers suitable in accordance with the invention can be ascertained from the known commercial products on the basis of the definition above by means of a few simple routine tests. Examples of those suitable are the products sold under the names SAG® 1572 (Momentive) and Silfoam® SE3060 (Wacker).

The silicone-based defoamers may also be used in the form of emulsions.

In one embodiment, defoamers of the invention may comprise silica. Silica refers for example to forms/modifications such as polysilicic acids, meta-silicic acid, ortho-silicic acid, silica gel, silicic acid gels, kieselguhr, precipitated SiO2, etc. The silica content can be modified within a wide range and is generally in the range from 0.1 to 10 percent by weight, preferably 0.2 to 5 wt %, more particularly 0.2 to 2 wt % of silica, based on the weight of polydimethylsiloxane.

The ratio of the invention between dynamic surface tension of the defoamer at a concentration of 2.0 g/l and at 20 ms in 20 wt % propylene glycol and the dynamic surface tension under the same conditions in 20 wt % dipropylene glycol is greater than 1.10. The measurement is made preferably at room temperature, i.e., in the range from 18 to 24° C.

Water used is preferably mains water of 15° DH (German hardness), preferably with an Mg fraction of 16 mg/l and a Ca fraction of 85 mg/l.

The dynamic surface tension is determined in accordance with the invention by the bubble pressure method, using for example a BP2100 tensiometer from Krüss GmbH.

In general, components a) to d) are present in the following amounts in the active ingredient compositions of the invention:
a) 1 to 40 wt % of one or more water-soluble active agrochemical ingredients,
b) 1 to 80 wt % of one or more N-alkylglucamides of the formula (I), as indicated above,
c) 0.005 to 10 wt % of one or more silicone-based defoamers of the invention, and
d) 0.1 to 97.995 wt %, preferably 5 to 85 wt %, more particularly 10 to 60 wt % of water.

The weight ratio of the active ingredients a) to the N-alkylglucamides b) is in general in the range from 1:80 to 40:1.

The weight ratio of the active ingredients a) to the defoamer c) is generally in the range from 1:10 to 40:0.02.

The weight ratio of the N-alkylglucamides b) to the defoamer c) is generally in the range from 1:10 to 80:0.02.

In general, for the active ingredient compositions of the invention, the total concentration of the active ingredients of component a) in the composition is more than 100 g/l, preferably more than 200 g/l, and more preferably more than 300 g/l, based on the acid equivalent thereof.

In general, for the active ingredient compositions of the invention, the total concentration of the alkylglucamide of the formula (I) in the composition is from 20 to 250 g/l, preferably from 40 to 200 g/l, and more preferably from 50 to 150 g/l.

In general, for the active ingredient composition of the invention, the total concentration of the defoamer c) in the composition is 0.05 to 100 g/l.

In a further preferred embodiment, the active ingredient composition of the invention, in addition to components a) to d), comprises
e) optionally one or more water-insoluble active agrochemical ingredients;
f) optionally one or more polar organic solvents;
g) optionally one or more anionic, cationic, zwitterionic and/or nonionic surfactants different from component b), and
h) optionally one or more formulating assistants different from components a) to g).

The active ingredient composition of the invention preferably consists of components a) to h).

Further preferred are aqueous active ingredient compositions of the invention, comprising
(a) 1 to 40 wt % of one or more water-soluble pesticides,
(b) 1 to 80 wt % of one or more alkylglucamides of the formula (I),

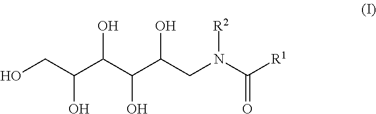

where
R1 is a linear or branched alkyl group having 5 to 9 carbon atoms,
R2 is an alkyl group having 1 to 3 carbon atoms,
(c) 0.005 to 10 wt % of one or more silicone-based defoamers of the invention,
(d) water,
(e) 0 to 40 wt % of one or more water-insoluble active agrochemical ingredients;
(f) 0 to 50 wt % of one or more polar organic solvents;
(g) 0 to 20 wt % of one or more anionic, cationic, zwitterionic and/or nonionic surfactants, different from component b), and
(h) 0 to 30 wt % of one or more formulating aids, different from components a) to g).

As component (e), the active ingredient compositions of the invention may also comprise active ingredients which are largely insoluble in water, examples being the abovementioned herbicides from the group of the diphenyl ethers such as oxyfluorfen, carbamates, thiocarbamates, triphenyltin and tributyltin compounds, haloacetanilides, phenoxyphenoxyalkanecarboxylic acid derivatives, and heteroaryloxyphenoxyalkanecarboxylic acid derivatives, such as quinolyloxy-, quinoxalyloxy-, pyridyloxy-, benzoxalyloxy-, and benzothiazolyloxy-phenoxyalkanecarboxylic esters, examples being diclofop-methyl, fenoxaprop-ethyl, or fenoxaprop-P-ethyl.

Also suitable are correspondingly insoluble active ingredients from classes of compound which normally comprise active ingredients of various solubilities, examples being active ingredients from the group of the cyclohexanedione derivatives, imidazolinones, pyrimidyloxypyridinecarboxylic acid derivatives, pyrimidyloxybenzoic acid derivatives, sulfonylureas, triazolopyrimidinesulfonamide derivatives, and also S—(N-aryl-N-alkylcarbamoylmethyl)dithiophosphoric esters.

Correspondingly, active ingredients from the group of the safeners, growth regulators, insecticides, and fungicides may also be suitable as component (e), preferably those already setout above.

The nature of the active ingredients used determines the type of pest organisms which can be controlled by employing the pesticide composition. In the case of herbicides, the pest organisms are unwanted plants.

In the context of the invention the term “polar organic solvents” (component (f)) refers for example to polar protic or aprotic polar solvents and mixtures thereof. Examples of solvents in the sense of the invention are aliphatic alcohols, such as lower alkanols, for example, such as methanol, ethanol, propanol, isopropanol, and butanol, or polyhydric alcohols such as ethylene glycol, glycerol, polar ethers such as tetrahydrofuran (THF), dioxane, alkylene glycol monoalkyl and dialkyl ethers, such as propylene glycol monoethyl ether, propylene glycol monoethyl ether, ethylene glycol monomethyl or monoethyl ethers, diglyme and tetraglyme; amides such as dimethylformamide (DMF), dimethylacetamide, dimethylcaprylamide, dimethylcaprimide (Hallcomides), and N-alkylpyrrolidones; ketones such as acetone; esters based on glycerol and carboxylic acids, such as glyceryl mono-, di-, and triacetate, lactams; carbonic diesters; nitriles such as acetonitrile, propionitrile, butyronitrile, and benzonitrile; and sulfoxides and sulfones such as dimethyl sulfoxide (DMSO) and sulfolane.

Also suitable frequently are combinations of different solvents, which additionally include alcohols such as methanol, ethanol, n- and isopropanol, and n-, iso-, tert-, and 2-butanol.

In the case of single-phase aqueous-organic solutions, the very or largely water-miscible solvents or solvent mixtures are suitable.

Preferred organic solvents in the sense of the invention are polar organic solvents such as N-methylpyrrolidone and propylene glycol monomethyl ether (e.g., Dowanol® PM).

The compositions of the invention may comprise as component (g) one or more anionic, cationic, zwitterionic or nonionic surfactants, different from component (b).

Examples of anionic surfactants are (where EO=ethylene oxide units, PO=propylene oxide units, and BO=butylene oxide units) as follows: g1) anionic derivatives of fatty alcohols having 10-24 carbon atoms with 0-60 EO and/or 0-20 PO and/or 0-15 BO in any order, in the form of ether carboxylates, sulfonates, sulfates, and phosphates, and their inorganic (e.g., alkali metal and alkaline earth metal) and organic salts (e.g., based on amine or on alkanolamine) such as Genapol#LRO, Sandopan® products, Hostaphat/Hordaphos® products from Clariant; g2) anionic derivatives of copolymers consisting of EO, PO and/or BO units with a molecular weight of 400 to 108 in the form of ether carboxylates, sulfonates, sulfates, and phosphates and their inorganic (e.g., alkali metal and alkaline earth metal) and organic salts (e.g., based on amine or on alkanolamine); g3) anionic derivatives of alkylene oxide adducts of C1-C6 alcohols in the form of ether carboxylates, sulfonates, sulfates, and phosphates, and their inorganic (e.g., alkali metal and alkaline earth metal) and organic salts (e.g., based on amine or on alkanolamine); g4) anionic derivatives of fatty acid alkoxylates in the form of ether carboxylates, sulfonates, sulfates, and phosphates, and their inorganic (e.g., alkali metal and alkaline earth metal) and organic salts (e.g., based on amine or on alkanolamine); g5) salts of aliphatic, cycloaliphatic, and olefinic carboxylic acids and polycarboxylic acids, and also alpha-sulfo fatty acid esters as available from Henkel; g6) sulfosuccinates, alkanesulfonates, paraffin and olefin sulfonates such as Netzer IS®, Hoe®S1728, Hostapur®OS, Hostapur®OSAS from Clariant, Triton® GR7ME and GR5 from Union Carbide, Empimin® products from Albright and Wilson, and Marlon®PS65 from Condea.

Preferred anionic surfactants are alkyl polyglycol ether sulfates, more particularly fatty alcohol diethylene glycol ether sulfate (e.g., Genapol LRO®, Clariant), or alkyl polyglycol ether carboxylates (e.g., 2-(isotridecyloxypolyethyleneoxy)ethyl carboxymethyl ether, Marlowet 4538®, Hüls).

The pesticide compositions of the invention optionally comprise further nonionic and/or cationic surfactants as component (g).

Examples of nonionic surfactants (for the surfactant component g) are as follows: g7) fatty alcohols having 10-24 carbon atoms with 0-60 EO and/or 0-20 PO and/or 0-15 BO in any order. Examples of such compounds are Genapol®C, L, O, T, UD, UDD, and X products from Clariant, Plurafac®- and Lutensol® A, AT, ON, and TO products from BASF, Marlipa1024 and 013 products from Condea, Dehypono products from Henkel, Ethylan® products from Akzo-Nobel such as Ethylan CD 120; g8) fatty acid and triglyceride alkoxylates such as the Serdox®NOG products from Condea or the Emulsogen products from Clariant; g9) fatty acid amide alkoxylates such as the Comperlan® products from Henkel or the Amam® products from Rhodia; g10) alkylene oxide adducts of alkynediols such as the Surfynol® products from Air Products; g11) glucitols from Clariant, g12) alkylpolyglycosides in the form of the APG® products from Henkel; g13) sorbitan esters in the form of the Span or Tween® products from Uniqema; g14) cyclodextrin esters or ethers from Wacker; g15) surface-active cellulose derivatives and algin, pectin, and guar derivatives such as the

tyloseo products from Clariant, the Manute® products from Kelco, and guar derivatives from Cesalpina; g16) poly-based alkylene oxide adducts such as Polyglykol® products from Clariant; g17) surface-active polyglycerides and derivatives thereof from Clariant.

Examples of cationic surfactants (for surfactant component g) are alkylene oxide adducts of fatty amines, and corresponding quaternary ammonium compounds having 8 to 22 carbon atoms, such as the Genamin C, L, O, and T products from Clariant, for example.

Also possible optionally are surface-active zwitterionic compounds such as taurides, betaines, and sulfobetaines in the form of Tegotain® products from Goldschmidt, Hostapon® T and Arkopon®OT products from Clariant (for surfactant component g).

Customary formulating assistants (h) are, for example, inert materials, such as stickers, wetters, dispersants, emulsifiers, penetrants, dyes, preservatives, and antifreeze agents, fillers, carriers, and dyes, evaporation inhibitors, and agents which influence the pH (buffers, acids, and bases) or the viscosity (e.g., thickeners). Preferred formulating assistants (h) are antifreeze agents and evaporation inhibitors such as glycerol or ethylene glycol, in an amount, for example, of 2 to 10 wt %, and preservatives, e.g., Mergal K9N® (Riedel) or Cobate C®. The formulations may also, as customary formulating assistants (h), further comprise defoamers of kinds other than those of component (c).

The assistants needed to produce the compositions of the invention, such as surfactants in particular, are known in principle and described for example in: McCutcheon's “Detergents and Emulsifiers Annual”, MC Publ. Corp., Ridgewood N.J.; and Wood, “Encyclopedia of Surface active Agents”, Chem. Publ. Co. Inc., N. Y. 1964; “Grenzflächenaktive Äthylenoxidaddukte”, Wiss. Verlagsgesellschaft, Stuttgart 1976; Winnacker-Küchler, “Chemische Technologie”, volume 7, C. Hanser-Verlag, Munich, 4th edition 1986, and literature cited in each of these.

The compositions of the invention can be produced by customary methods, that is, for example, by mixing the components with stirring or shaking or by means of static mixing methods. The liquid formulations obtained are stable with good storage qualities.

The invention also provides aqueous adjuvant compositions which can be used for producing the concentrated active ingredient composition of the invention or for producing tank mixers with active ingredient compositions, or else may be applied separately, simultaneously or sequentially with the application of pesticides or fertilizers (preferably the stated pesticides (a)), to the plants or to the soil on or in which the plants are growing.

Features of adjuvant compositions of this kind are that they are free from active agrochemical ingredients, especially pesticides, and comprise

b) one or more glucamides of the invention, of the formula (I), and
c) one or more defoamers of the invention, and
d) water, and also comprise
optionally polar organic solvents (f), optionally further surfactants (h), different from component b), and optionally other customary formulating assistants (h), with the components (b), (c), (d), (f), (g), and (h) being defined as in the case of the active ingredient compositions of the invention.

The compositions comprising active ingredient and the adjuvant compositions are low-foam compositions with good storage qualities. In application, they generally have very favorable technical qualities.

For example, the compositions of the invention are distinguished by low foaming tendency on dilution with water, as for example during the production of tank mixes or during application by a spraying method. Moreover, the active ingredient compositions and the adjuvant compositions of the invention, in use together with pesticides/pesticide formulations, have a comparatively very good biological activity.

Accordingly the active ingredient compositions of the invention are especially suitable for applications in which the compositions are applied to the plants, parts of plants, or the area under cultivation.

In the case of herbicides a) and/or e), the compositions of the invention are highly suited to the control of unwanted plant growth both on noncrop land and in tolerant crops.

The invention is elucidated in more detail by the examples, without being restricted by them.

### EXAMPLES

In the examples below, quantity figures are by weight unless otherwise indicated.

Glucamides of the invention used were as follows:

GA1: 50 wt % of a mixture of 50 to 70 wt % of C8 glucamide and 30 to 50 wt % of C10 glucamide, 5 wt % of propylene glycol, and 45 wt % of water.

Defoamers (ES) of the invention used were as follows:

CES1: Tego Antifoam 793 (Evonik) (comparison substance)

### ES1: Silfoam SE3060 (Wacker)

### ES2: SAG 1572 (Momentive)

### Dynamic Surface Tension (DYOS)

The dynamic surface tension was determined via the bubble pressure method (BP2100 tensiometer, Krüss), with a time span (referred to as surface age) of 20 milliseconds as relevant for the spray application of agrochemicals in aqueous dilution.

TABLE 1

| | Concentration | | DYOS |
|---|---|---|---|
| Defoamer | [g/l] | Solvent | [mN/m] (20 ms) |
| CES1 5) | 2.0 | H2O/20 wt % PG 1) | 40.60 (DYOS1) |
| CES1 5) | 2.0 | H2O/20 wt % DPG 2) | 39.00 (DYOS2) |
| CES1 5) | 2.0 | H2O 3) | 30.00 (DYOS3) |
| ES1 | 2.0 | H2O/20 wt % PG 1) | 51.50 (DYOS1) |
| ES1 | 2.0 | H2O/20 wt % DPG 2) | 43.30 (DYOS2) |
| ES1 | 10.0 | H2O 3) | 18.90 (DYOS3) |
| ES2 | 2.0 | H2O/20 wt % PG 1) | 52.00 (DYOS1) |
| ES2 | 2.0 | H2O/20 wt % DPG 2) | 42.80 (DYOS2) |
| ES2 | 10.0 | H2O 3) | 36.80 (DYOS3) |

1) PG = Propylene glycol
2) DPG = Dipropylene glycol
3) H2O = Mains water of 15° DH (German hardness)
5) = CES = Comparison defoamer

TABLE 2
Ratio of DYOS1/DYOS2 and DYOS1/DYOS3

| Defoamer | DYOS1/DYOS2 | DYOS1/DYOS3 |
|---|---|---|
| CES1 | 1.04 | 1.35 |
| ES1 | 1.20 | 2.72 |
| ES2 | 1.14 | 2.49 |

In accordance with the invention, accordingly, are defoamers ES1 and ES2, for which both ratios are greater than 1.10.

### Foam Behavior

One of the important properties of surface-active substances is the foam behavior, especially in aqueous systems. Virtually all surfactants form foam, and in the case of critical (highly foaming) surfactants, the time which elapses before foam collapse must be shortened by adding defoamers to the formulation or aqueous preparation for application. The foam behavior of some of the compositions of the invention was characterized by the foam test of CIPAC Method MT42.2, using aqueous solutions at the stated concentrations. The values in the table show the percentage filling with foam in a cylinder over a period of 12 minutes. A value of 100(%) thus denotes maximum foam and is obtained, for example, over the entire period of 12 minutes with lauryl ether sulfates (such as Genapol LRO).

Using the compositions of the invention as examples, the tables below show that the foam behavior can be classified as very favorable. At concentrations ranging from typical for use in aqueous agrochemical spray mixtures up to relatively high, foam collapse is very rapid.

### Example 1

### Foam Test (* % Foam Based on the Maximum According to CIPAC MT42.2) at a Concentration of 2.5% GA1 in the Spray (20 ppm and 342 ppm (CIPAC D))

| CIPAC MT42.2 foam test | | | | | | |
|---|---|---|---|---|---|---|
| 2.5% GA1 | 20 ppm | | | 342 ppm | | |
| Defoamer at x % of GA1 | 1 min | 3 min | 6 min | 1 min | 3 min | 6 min |
| No defoamer | 100 | 100 | 100 | 100 | 100 | 100 |
| ES1 (0.1%) | | | | 10 | 8 | 2 |
| ES1 (0.03%) | | | | 2 | 1 | 0 |
| ES1 (0.1%) | | | | >35 | >35 | >35 |
| ES1 (0.01%) | | | | >35 | >35 | >35 |
| ES2 (0.1%) | 3 | 3 | 3 | 5 | 3 | 1 |
| ES2 (0.03%) | | | | 13 | 3 | 3 |
| ES2 (0.01%) | | | | >35 | 24 | 11 |

At a concentration of 2.5% GA1 in the spray, foam behavior is improved for certain, routinely determined concentrations of the defoamers relative to pure GA1

1. ES1 at 0.01-0.05%, preferably 0.03%
2. ES2 at above 0.02%, preferably 0.03%.

### Example 2

### CIPAC Foam Test at a Concentration of 1.0% GA1 in the Spray (342 ppm (CIPAC D))

| CIPAC foam test | | | |
|---|---|---|---|
| 1% GA1 | 342 ppm | | |
| Defoamer | 1 min | 3 min | 12 min |
| No defoamer | >35 | >35 | >35 |
| ES2 (0.03%) | 7 | 3 | 2 |
| ES1 | 18 | 10 | 6 |
| CES1 | 34 | 34 | 28 |

At 1.0% of GA1, clearly superior performance of ES2 for a minimum concentration of 0.03% of GA1.)

### Example 3

### CIPAC Foam Test at a Concentration of 0.25% of GA1 in a Spray (342 ppm (CIPAC D))

At this concentration, ES2 at a concentration of just 0.01% (based on GA1) reduces the foam completely.

### Example 4

### Foam Reduction in Electrolyte-Containing Herbicide Formulations

In a salt-containing formulation of GA1 (80% GA1 and 20% ammonium sulfate), ES2 at a concentration merely of at least 0.01% (based on 80% GA1 and 20% ammonium sulfate) reduces the foam completely.

1. An aqueous agrochemical active ingredient composition comprising
(a) at least one water-soluble active agrochemical ingredient,
(b) at least one alkylglucamide of the formula (I), 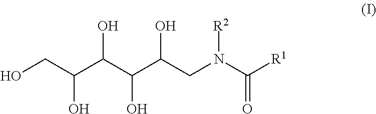
where
R1 is a linear or branched alkyl group having 5 to 9 carbon atoms,
R2 is an alkyl group having 1 to 3 carbon atoms,
(c) at least one silicone-based defoamer selected from the group consisting of linear polydimethylsiloxanes, and
(d) water,
where for the defoamer c) the ratio of dynamic surface tension at a concentration of 2.0 g/l and a surface age of 20 ms in 20 wt % strength aqueous propylene glycol to the dynamic surface tension under the same conditions in 20 wt % strength aqueous dipropylene glycol is greater than 1.10 and the ratio of the dynamic surface tension at a concentration of 2.0 g/l and a surface age of 20 ms in 20 wt % strength aqueous propylene glycol to the dynamic surface tension at a concentration of 10.0 g/l and a surface age of 20 ms in mains water is greater than 1.10.

2. The composition as claimed in claim 1, wherein R1 is a linear or branched alkyl group having from 7 to 9 carbon atoms and R2 is a methyl group.

3. The composition as claimed in claim 1, wherein the at least one alkylglucamide of the formula (I) comprise a mixture of octyl-N methylglucamide, R1=C7 alkyl, and decyl-N methylglucamide, R1=C9 alkyl, and the fraction of octyl-N methylglucamide is 10 to 90 wt %, and the fraction of decyl-N-methylglucamide is 10 to 90 wt %, based on the total amount of the alkylglucamides present in this mixture.

4. The composition as claimed in claim 1, wherein the fraction of the at least one alkylglucamide of the formula (I) is a) 1 to 80 wt %, based on the total weight of the composition.

5. The composition as claimed in claim 1, wherein the at least one water-soluble active agrochemical ingredient of component a) is selected from the group consisting of herbicides.

6. The composition as claimed in claim 5, wherein the at least one water-soluble active ingredient of component a) is selected from the group consisting of water-soluble salts of 2,4-D, bentazone, dicamba, fomesafen, glyphosate, glufosinate, MCPA, and paraquat.

7. The composition as claimed in claim 1, wherein the composition comprises at least two water-soluble active agrochemical ingredients, of component a).

8. The composition as claimed in claim 7, wherein the water-soluble active ingredient of component a) is selected from the group of combinations consisting of glyphosate and 2,4-D; glyphosate and dicamba; glyphosate and fomesafen; glyfosate and glufosinate; 2,4-D and dicamba; glufosinate and 2,4-D; and glufosinate and dicamba.

9. The composition as claimed in claim 1, wherein the total concentration of the active ingredients of component a) in the composition is greater than 100 g/l, based on the acid equivalent thereof.

10. The composition as claimed in claim 1, wherein the total concentration of the alkylglucamides of the formula (I) in the composition is from 20 to 250 g/l.

11. The composition as claimed in claim 1, wherein the total concentration of the defoamer c) is 0.05 to 100 g/l.

12. The composition as claimed in claim 1, further comprising
e) optionally at least one water-insoluble active agrochemical ingredient;
f) optionally at least one polar organic solvent;
g) optionally at least one anionic, cationic, zwitterionic and/or nonionic surfactant different from component b), and
h) optionally at least one formulating assistant different from components a) to g).

13. An aqueous agrochemical adjuvant composition which is free from active agrochemical ingredients, comprising
A) at least one glucamide of the formula (I) 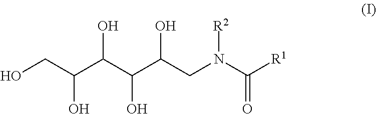
where
R1 is a linear or branched alkyl group having 5 to 9 carbon atoms,
R2 is an alkyl group having 1 to 3 carbon atoms,
and
B) at least one silicone-based defoamer selected from the group consisting of linear polydimethylsiloxanes,
where for the defoamer c) the ratio of dynamic surface tension at a concentration of 2.0 g/l and a surface age of 20 ms in 20 wt % strength aqueous propylene glycol to the dynamic surface tension under the same conditions in 20 wt % strength aqueous dipropylene glycol is greater than 1.10 and the ratio of the dynamic surface tension at a concentration of 2.0 g/l and a surface age of 20 ms in 20 wt % strength aqueous propylene glycol to the dynamic surface tension at a concentration of 10.0 g/l and a surface age of 20 ms in mains water is greater than 1.10.

14. A method for controlling unwanted plant growth, which comprises applying an effective amount of a composition comprising
(a) at least one water-soluble active agrochemical ingredient,
(b) at least one alkylglucamide of the formula (I), 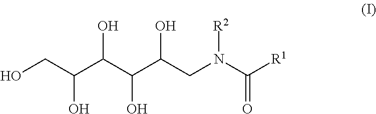
where
R1 is a linear or branched alkyl group having 5 to 9 carbon atoms,
R2 is an alkyl group having 1 to 3 carbon atoms,
(c) at least one silicone-based defoamer selected from the group consisting of linear polydimethylsiloxanes, and
(d) water,
where for the defoamer c) the ratio of dynamic surface tension at a concentration of 2.0 g/l and a surface age of 20 ms in 20 wt % strength aqueous propylene glycol to the dynamic surface tension under the same conditions in 20 wt % strength aqueous dipropylene glycol is greater than 1.10 and the ratio of the dynamic surface tension at a concentration of 2.0 g/l and a surface age of 20 ms in 20 wt % strength aqueous propylene glycol to the dynamic surface tension at a concentration of 10.0 g/l and a surface age of 20 ms in mains water is greater than 1.10,
to the plants, parts of plants, or the area under cultivation.

15. A method for defoaming a liquid aqueous formulation of water-soluble active agrochemical ingredients comprising at least one alkylglucamide of the formula (I) 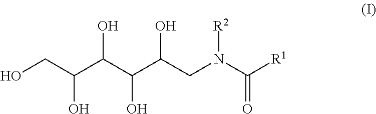
where
R1 is a linear or branched alkyl group having 5 to 9 carbon atoms,
R2 is an alkyl group having 1 to 3 carbon atoms,
comprising the step of adding at least one silicone-based defoamer selected from the group consisting of linear polydimethylsiloxanes to the liquid aqueous formulation, where for the at least one silicone-based defoamer the ratio of dynamic surface tension at a concentration of 2.0 g/l and a surface age of 20 ms in 20 wt % strength aqueous propylene glycol to the dynamic surface tension under the same conditions in 20 wt % strength aqueous dipropylene glycol is greater than 1.10 and the ratio of the dynamic surface tension at a concentration of 2.0 g/l and a surface age of 20 ms in 20 wt % strength propylene glycol to the dynamic surface tension at a concentration of 10.0 g/l and a surface age of 20 ms in mains water is greater than 1.10.
